(19) United States
(12) Patent Application Publication
(10) Pub. No.: US 2017/0076060 A1
(43) Pub. Date: Mar. 16, 2017

(54) MEDICATION DISPENSING DEVICE AND METHODS

(71) Applicant: CARDINAL HEALTH COMMERCIAL TECHNOLOGIES, LLC, DUBLIN, OH (US)

(72) Inventors: MARK ALLEN PILKINGTON, POWELL, OH (US); BENJAMIN ELI STORMER, WORTHINGTON, OH (US); DANIEL LEE MICHAEL, AURORA, OH (US); JASON R. ERTEL, TWINSBURG, OH (US); VIKKI NOWAK, CLEVELAND HEIGHTS, OH (US); MARK Wladimir Gilicinski, DUBLIN, OH (US); Indira Akurathi, COLUMBUS, OH (US)

(73) Assignee: CARDINAL HEALTH COMMERCIAL TECHNOLOGIES, LLC, DUBLIN, OH (US)

(21) Appl. No.: 15/216,488

(22) Filed: Jul. 21, 2016

Related U.S. Application Data
(60) Provisional application No. 62/196,131, filed on Jul. 23, 2015.
(60) Provisional application No. 62/196,165, filed on Jul. 23, 2015.
(60) Provisional application No. 62/314,719, filed on Mar. 29, 2016.

(51) Int. Cl. G06F 19/00

(52) U.S. Cl. CPC G06F 19/3456; G06F 19/3431; G06F 19/322

(57) ABSTRACT

A method and system for managing various aspects of a patient's health, such as medications, testing, subjective evaluation, communications, education, and appointments (such method and system also referred to as a “wellness solution”). The wellness solution may include a medication dispensing device, including multiple trays for holding medication, and/or use thereof. The wellness solution may also include a pharmacy application allowing a pharmacist to manage a medication schedule of a patient and upcoming patient appointments, among other features. The pharmacy application may also allow a pharmacist to monitor for health changes in a patient, change prescription schedules for the patient, and help educate a patient, for example.

### RELATED APPLICATIONS

This application claims priority to U.S. Provisional Patent Application No. 62/196,131, filed on Jul. 23, 2015, titled, “MEDICATION DISPENSING DEVICE AND METHODS,” U.S. Provisional Patent Application No. 62/196,165, filed on Jul. 23, 2015, titled “MEDICATION DISPENSING DEVICE AND METHODS,” and U.S. Provisional Patent Application No. 62/314,179, filed on Mar. 28, 2016, titled, “MEDICATION DISPENSING DEVICE AND METHODS OF USE THEREOF.” The entirety of each of these applications is hereby incorporated by reference.

### BACKGROUND

Patients may be prescribed multiple medications to treat various conditions. Additionally, patients may regularly take non-prescription drugs (e.g., aspirin) or supplements. Accordingly, some patients may need to manage a regimen involving multiple medications.

Current medication management solutions, such as pill sorters, still require the patients or caregivers to manually sort and track medications. Compliance with a complicated medication regimen may be difficult for patients. Further, care providers may not know whether a patient is complying with a medication regimen, which may affect the ability of the care provider to assess the effectiveness of the medication regimen.

In view of the foregoing, as well as other factors, there remains a need for improvements over current medication dispensing procedures.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure provides for a method and system for managing various aspects of a patient's health, such as medications, testing, subjective evaluation, communications, education, and appointments (such method and system also interchangeably referred to herein as a “wellness solution”). The wellness solution may include a system and method that includes a medication dispensing device, including multiple trays for holding medication, and/or use thereof. The medication dispensing device may include one or more load cells configured to measure the mass of the medication in the trays. The medication dispensing device may include a user interface for communicating with the patient or caregiver and a control system and method for controlling access to the trays. The medication dispensing device may receive medication information and may use the medication information to alert the patient to take a dose of the medication according to a regimen, for example. The medication dispensing device may also interact with the patient to obtain biometric information and subjective health information, for example. The medication dispensing device may communicate with a network to provide regimen compliance information, for example, along with the collected biometric and/or subjective health information.

The system and method may also include a pharmacy application allowing a pharmacist to manage a medication schedule of a patient and upcoming patient appointments, among other features. The pharmacy application may also allow a pharmacist to monitor for health changes in a patient, change prescription schedules for the patient, and help educate a patient, for example.

The system and method may also optionally include one or more computer servers for managing the medication dispensing device, pharmacy applications, web applications running on the system, and any other devices interacting with the system. The computer servers may also receive data generated by the medication dispensing device, the pharmacy application, and/or devices interacting with the system and may analyze the received data and perform calculations on the received data.

Additional advantages and novel features of these aspects will be set forth in part in the description that follows, and in part will become more apparent to those skilled in the art upon examination of the following or upon learning by practice thereof.

### BRIEF DESCRIPTION OF THE DRAWINGS

The disclosed aspects will hereinafter be described in conjunction with the appended drawings, provided to illustrate example features and not to limit the disclosed aspects, wherein like designations denote like elements, and in which:

FIG. 1 illustrates an example system including a medication dispensing device for use in accordance with an aspect;

FIG. 2 illustrates an example method flow for initializing a medication dispensing device in accordance with an aspect;

FIGS. 3A-3E illustrate an example method flow for managing a medication schedule for a patient in accordance with an aspect;

FIG. 4 illustrates an example method flow for prompting a patient to take medicine in accordance with an aspect;

FIG. 5 illustrates an example method flow for gathering information from peripheral devices in accordance with an aspect;

FIG. 6 illustrates an example method flow for gathering health and wellness information in accordance with an aspect;

FIGS. 7A and 7B illustrate an example method flow for establishing a travel mode in accordance with an aspect;

FIG. 8 illustrates an example method flow for calculating a compliance score in accordance with an aspect;

FIG. 9 illustrates an example method flow for transmitting alerts in accordance with an aspect;

FIG. 10 illustrates an example method flow for determining behavioral analytics in accordance with an aspect;

FIG. 11 illustrates an example method flow for risk management in accordance with an aspect;

FIG. 12 illustrates an example chart generated by the system for comparing dose adherence with an associated biometric test result.

### DETAILED DESCRIPTION

Various aspects are now described with reference to the drawings. In the following description, for purposes of explanation, numerous specific example details are set forth in order to provide a thorough understanding of one or more aspects. It may be evident, however, that such aspects may be practiced without these specific details.

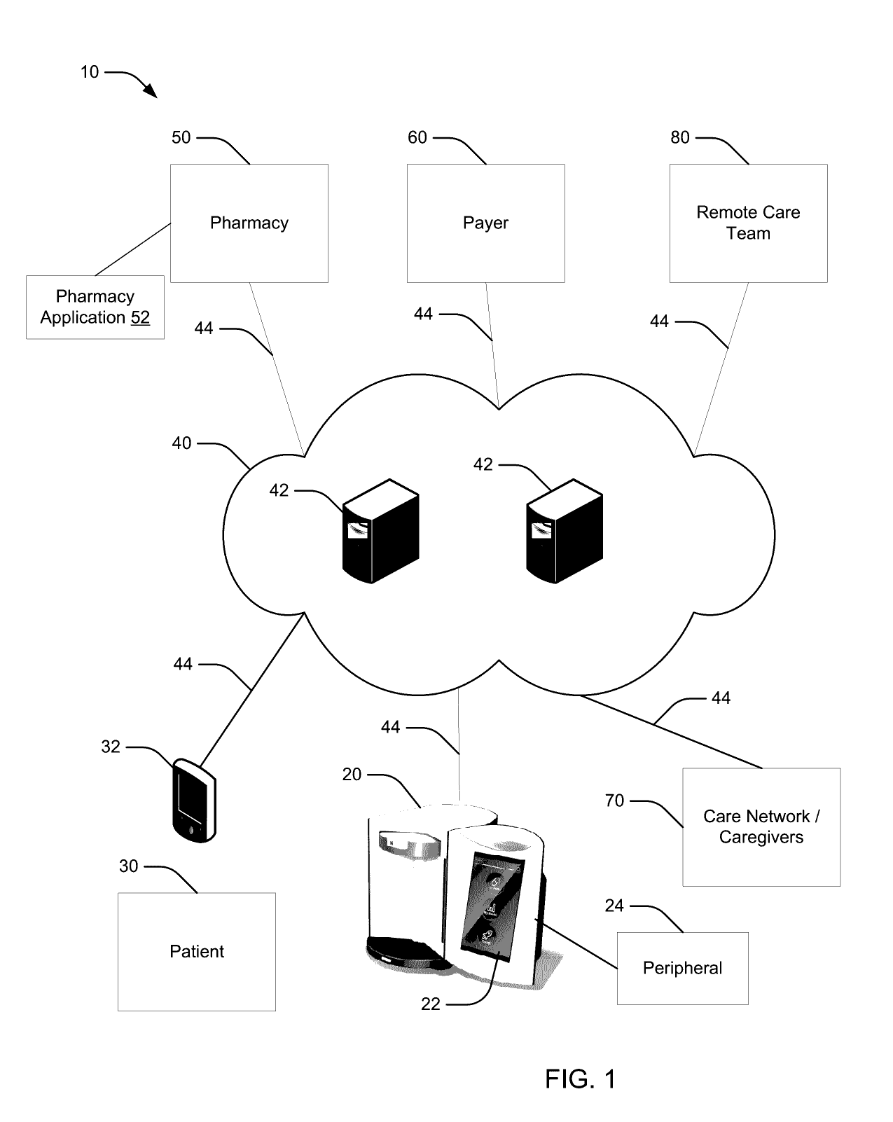

FIG. 1 illustrates an example system 10 including features for operating a wellness solution for managing various aspects of a patient's health, such as medications, testing, subjective evaluation, communications, education, and appointments, and method of operation thereof (see also applicant's co-pending U.S. patent application Ser. No. 15/216,385, titled Medication Dispensing Device and Methods, which is incorporated by reference herein, for an example system and operation thereof usable herewith). System 10 may include a medication dispensing device 20. Medication dispensing device 20 may store medications (e.g., solid oral medications) to be dispensed to a patient 30. Medication dispensing device 20 may be located in the patient's home, office or other convenient location, for example. Medication dispensing device 20 may dispense (or allow patients to access) one or more medications to the patient at various times according to prescribed schedules. Medication dispensing device 20 may include multiple trays for holding pods containing medication. In addition, medication dispensing device 20 may include a clock to measure the time medications were dispensed or accessed, and may further include one or more load cells to measure the weight of the medication removed from pods placed on the trays. Medication dispensing device 20 may also include a user interface 22 for displaying the time, medication alerts, and other medication information, and for allowing the patient to control the dispensing of medication from the dispensing device 20.

Medication dispensing device 20 may communicate with the patient 30 via, for example, the user interface 22. Medication dispensing device 20 may also communicate with the patient 30 via other features (e.g., an alarm), a peripheral device 24, and/or a patient mobile device 32. In an aspect, a caregiver 70 or other party, such as a member of a care network, a family member, a pharmacist, or medical provider, may interact with medication dispensing device 20.

The dispensing device 20 may work in conjunction with a peripheral device 24 that obtains medical or biometric data from a patient. For example, the peripheral device 24 may comprise a glucometer, cardiac monitor, thermometer, respiratory monitor, sleep monitor, pulse oximeter, body scale, inhaler, nebulizer, fitness tracker, blood pressure cuff, syringe, stethoscope, breathalyzer, mobile telephone sensor, etc. The peripheral device 24 may provide measurements or biometric data to the medication dispensing device 20, for example, which may in turn transmit the measurements or biometric data to other devices or medical professionals via a network 40. In addition, the peripheral device 24 may provide measurements or biometric data to the medication dispensing device 20, which may in turn transmit the measurements or biometric data to server 42.

Medication dispensing device 20 may be communicatively coupled to a network 40. Network 40 may include any network suitable, including, for example, the Internet, that allows communication between the various entities of the system 10. In an aspect, network 40 may be a communications network and may include or be connected with other networks. For example, medication dispensing device 20 may include a modem and may be coupled to network 40 via a wired or wireless connection. Network 40 may include one or more computer servers 42. Computer server(s) 42 may include information for managing medication dispensing device 20 and/or a peripheral device 24. In an aspect, for example, computer servers 42 may include device servers for controlling one or more medication dispensing devices 20, notification servers for providing messages to the patient 30, caregivers 70, or others, such as a remote care team 80. Servers 42 may also receive data generated by medication dispensing device 20 and/or peripheral device 24. Computer server(s) 42 may include one or more analyzing servers for analyzing the received data and/or one or more calculating servers for performing calculations on the received data. In an aspect, various calculations and other processing described herein may be performed by one or more servers 42, the medication dispensing device 20, or a combination of the servers 42 and the medication dispensing device 20. For example, the medication dispensing device 20 may send raw data to a server 42 or may perform processing on the data before sending the processed data to the server 42. Computer server(s) 42 may also include one or more web servers running web applications that may allow a pharmacy 50, for example, payer 60, caregivers 70, or others, such as the remote care team 80 to interact with the system 10 in defined roles. For example, the pharmacy 50 may access servers 42 via a pharmacy application 52. Computer servers 42 may also include storage servers for storing device information, medication information, patient information, billing information, etc.

In one aspect of the disclosure, various data may be, for example, input and/or accessed by the patient 30, pharmacy 50, payer 60, caregivers 70, or other users via terminals, such as personal computers (PCs), minicomputers, mainframe computers, microcomputers, telephonic devices, or wireless devices, personal digital assistants (“PDAs”), and/or other hand-held wireless devices (e.g., tablet computer). The terminals may be coupled to a computer server 42, such as a PC, minicomputer, mainframe computer, microcomputer, or other device having a processor and a repository for data and/or connection to a repository for data, via, for example, the network 40, such as the Internet or an intranet, and/or a wireless network. The couplings 44 may include, for example, wired, wireless, or fiber optic links.

Medication dispensing device 20 may dispense medications provided by a pharmacy 50 or other appropriately licensed entity, such as a physician office. In an aspect, a medication may include a solid oral medication (e.g., pills, caplets, capsules, gel caps, or tablets). In an aspect, the medication may include a prescription medication. The medication may also include over the counter medicine, vitamins, supplements, placebos, experimental drugs not yet approved for sale, or other substances that may be dispensed to the patient 30. The pharmacy 50 may provide medications to the patient for storage in the medication dispensing device 20. The pharmacy 50 may receive prescription information from a doctor via written or electronic script, for example. In addition, the pharmacy 50 may receive prescription information via the network 40, such as through the pharmacy application 52. The pharmacy 50 may also receive prescription information from an electronic medical record of the patient. The pharmacy 50 may fill the prescription and provide the medications to the patient 30 or caregiver 70 in a medication container, for example. The pharmacy 50 may submit medication information to the network 40 using the pharmacy application 52, indicating the type, total mass, container mass, mass per dose, and/or other medication properties for each medication.

When the patient is due for refills on one or more of their medications, the patient may receive a “quantity sufficient refill” tied to the patient's dose compliance and/or adherence. Conventionally, a patient requests a refill from a pharmacy at regular intervals (e.g. 30 or 90 days) and receives a quantity of pills commensurate with the number of doses in that interval regardless of how many pills were actually taken by the patient in the previous interval. A quantity sufficient refill refers to an amount of medication required to “top off” a patient's existing supply of a particular medication to a prescribed amount for a time period (e.g., an appropriate amount for proper ingestion in a 30 day period). The pharmacy application 52 may receive current, real-time medication quantities stored in medication dispensing device 20 via the network 40 to determine the quantity sufficient refill amount. For example, the dispensing device 20 may indicate to the pharmacy that six pills of a particular medication are present in the device 20 by measuring the weight of the corresponding medication pod. Alternatively, the dispensing device 20 may indicate to the pharmacy that the patient was 80% compliant with the particular medication since the date of the last refill. Accordingly, the pharmacy issuing a refill of that medication may only dispense twenty-four pills as a quantity sufficient refill in order to bring the total pill count in the device 20 to thirty pills (enough for a standard 30-day period). Among other things, providing a quantity sufficient refill may reduce waste from missed doses, may reduce excess amounts of potentially dangerous medications in a patient's home, and reduce medication costs for patients and payers.

The payer 60 may receive billing information from the network 40 and provide payment. For example, a server 42 may include a billing server that receives bills from the pharmacy 50 and provides the bills to the payer 60.

The remote care team 80 may receive information from the network 40 regarding a patient 30 and operations of the medication dispensing device 20. The remote care team, for example, may monitor for health changes and change prescription schedules.

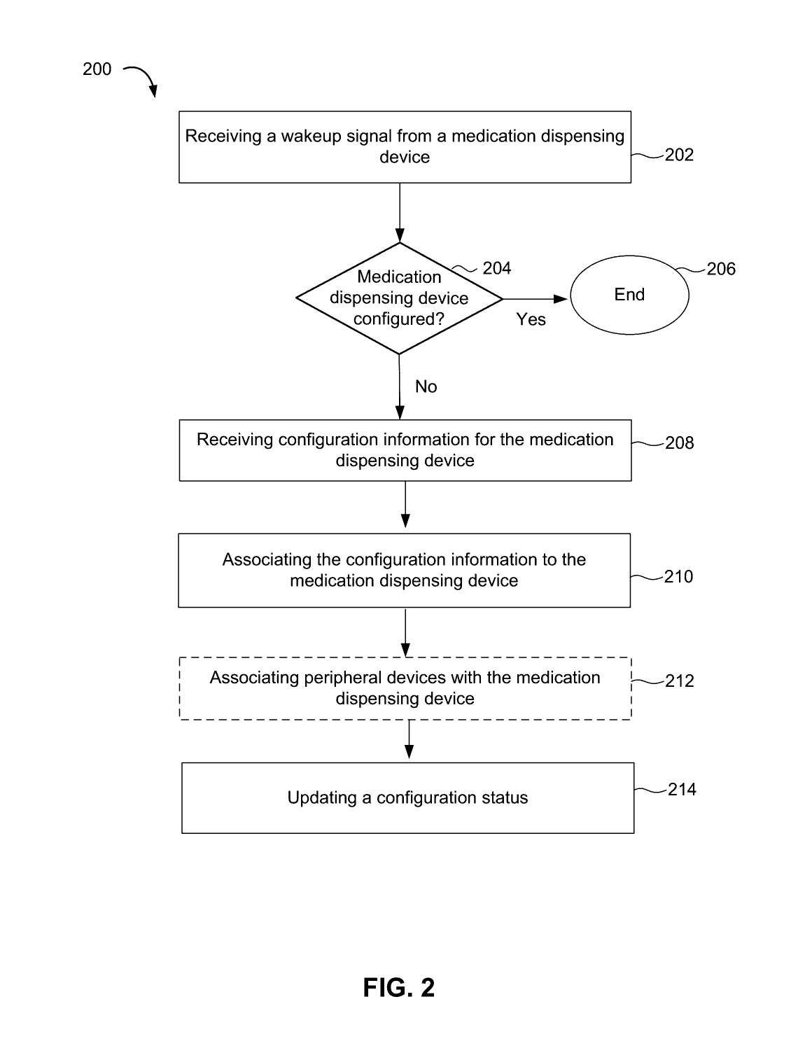

Referring now to FIG. 2, illustrated therein is an example method flow 200 for initializing a medication dispensing device in accordance with an aspect. The method may include receiving a wakeup signal from a medication dispensing device 202. The wakeup signal may include, for example, a device identification, a device configuration status, and a device location. In an aspect, server 42 (FIG. 1) may receive the wakeup signal from medication dispensing device 20 (FIG. 1) when a user powers on, or otherwise activates, medication dispensing device 20. For example, an administrator, such as, a pharmacist may power on medication dispensing device 20 in a pharmacy and medication dispensing device 20 may transmit a wakeup signal to server 42 via network 40 (FIG. 1) after medication dispensing device 20 is enabled (e.g., turned on). In addition, a patient may power on, or otherwise activate, medication dispensing device 20. In an aspect, an administrator may, for example, power on medication dispensing device 20 and select a button or icon on interface 22 (FIG. 1) to initiate the wakeup signal.

The method may also include determining whether the medication dispensing device has been configured 204. In an aspect, server 42 may receive the wakeup signal from medication dispensing device 20 and may check the device configuration status to determine whether medication dispensing device 20 has been previously set up with system 10 (FIG. 1). For example, when the device configuration status indicates that medication dispensing device 20 has previously registered with system 10, server 42 may determine that medication dispensing device 20 has been previously configured with system 10 and the method may end 206.

However, if, for example, server 42 determines that medication dispensing device 20 has not been configured with system 10, the method may include receiving configuration information for the medication dispensing device 208. Configuration information may include, for example, patient information, medication information, and peripheral devices which may be connected to the dispensing device. Patient information may include, but is not limited to, a patient name, a patient identification, patient contact information, caregivers' contact information, physician information, insurance information, medical history information, medical records, and appointment information. In addition, medication information may include, but is not limited to, medications prescribed to a patient, medication strength, medication dosage schedules, warnings, and instructions. The patient information and the medication information may be received by the system through user input. For example, an administrator may enter the patient information and medication information using pharmacy application 52 (FIG. 1). In addition, the system may receive the patient information and the medication information from a medical provider. For example, server 42 may retrieve the medical information and/or patient information from a medical provider's computer system or other third party systems.

A patient account on server 42 may store the patient information, medication information, medical information, and/or health information received for the patient. For example, an administrator may create the patient account using pharmacy application 52 and server 42 may identify the patient account using the patient identification. In addition, server 42 may update the patient account information to include the device identifier of medication dispensing device 20. As such, the system may easily identify the medication dispensing device associated with the patient.

The method may also include associating the configuration information with the medication dispensing device 210. In an aspect, server 42 may synchronize medication dispensing device 20 with the patient account. Server 42 may transmit to medication dispensing device 20 the patient information, the medication information, medical information, and/or health information from the patient account. Server 42 may periodically transmit the patient information and medication information to the medication dispensing device. In addition, server 42 may transmit the patient information and medication information to medication dispensing device 20 in real time or near real time as updates occur to the patient account.

Optionally, the method may include associating peripheral devices with the medication dispensing device 212. For example, the administrator, the patient, a family member, and/or a caregiver of the patient may identify peripheral devices to associate with the medication dispensing device. The peripheral devices may include any suitable device that may obtain medical or biometric data from a patient. For example, the peripheral devices may be a glucometer, cardiac monitor, thermometer, respiratory monitor, sleep monitor, pulse oximeter, body scale, inhaler, nebulizer, fitness tracker, blood pressure cuff, syringe, stethoscope, breathalyzer, mobile phone sensor, etc. In an aspect, peripheral devices 24 (FIG. 1) may be connected to medication dispensing device 20 through a wired (e.g., universal serial bus (USB) connection or a wireless (e.g., Bluetooth) connection. For example, an administrator or a user may identify one or more peripheral devices 24 to connect to medication dispensing device 20 and may synchronize the selected peripheral devices 24 to medication dispensing device 20. Peripheral devices 24 may provide measurements or biometric data and/or other information to medication dispensing device 20, which may in turn transmit the relevant information to server 42 and/or other devices via network 40. In addition, the peripheral devices may include devices that are not coupled to the medication dispensing device and the patient may enter measurements or other readings taken by the peripheral device into the system.

In addition, the method may include updating a device configuration status 214. For example, when the medication dispensing device 20 has been setup by the administrator, the server 42 may update the configuration status to indicate that the medication dispensing device 20 is registered with the system 10 and has been initialized with patient information and patient medication information.

Once the medication dispensing device has been set up by the administrator, the administrator may demonstrate to the patient how the medication dispensing device operates. For example, the administrator may schedule an appointment with the patient to demonstrate functions of the medication dispensing device and any peripheral devices the patient may need to use. The administrator may also explain to the patient any third party monitoring that may occur through the medication dispensing device. The patient may practice using the medication dispensing device during this appointment with the administrator so that the administrator may confirm that the patient is capable of operating the device. In addition, the administrator may answer any questions the patient may have regarding operation of the medication dispensing device, operation of the peripheral devices, and/or any third party monitoring. The administrator may help the patient pack up the device and any medication for transport (e.g., to the patient's home).

In another aspect, a family member and/or caregiver of the patient may meet with the administrator to receive the medication dispensing device and/or any medications required for the medication dispensing device. The administrator and/or the system may require a special authentication for family members and/or caregivers to act on behalf of the patient.

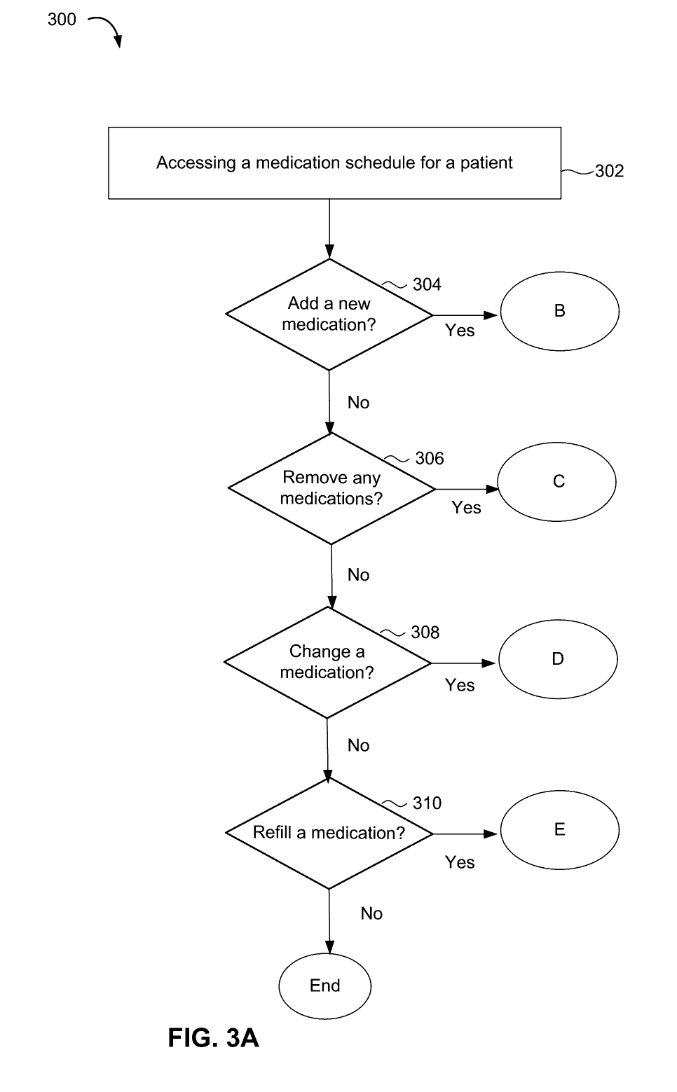

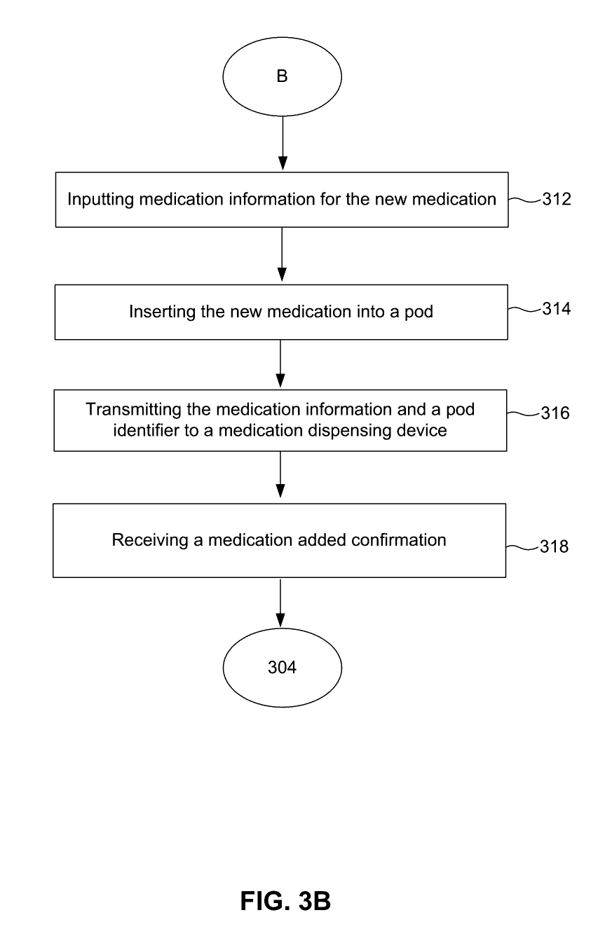

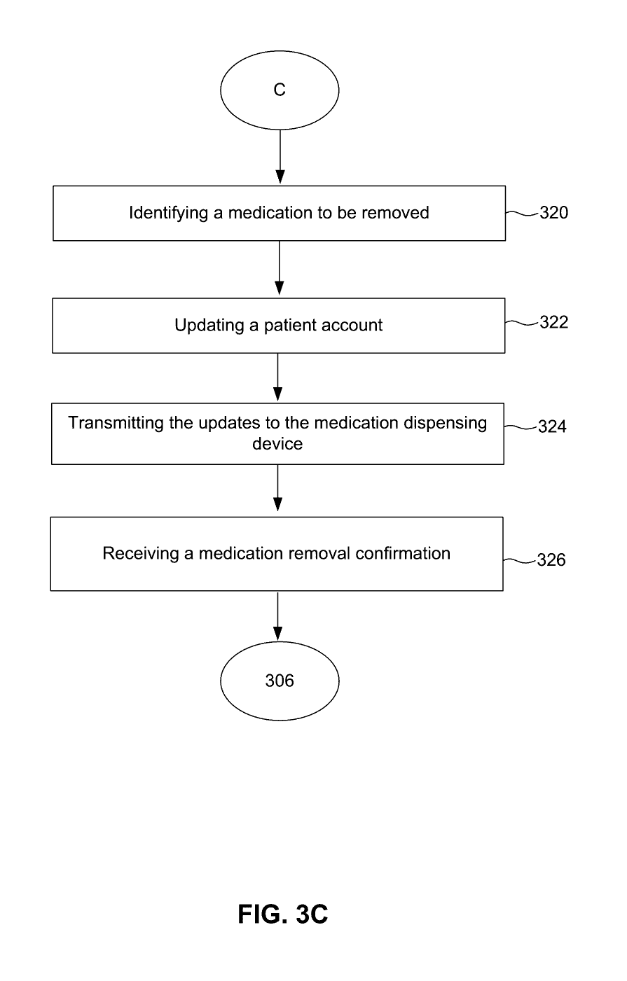

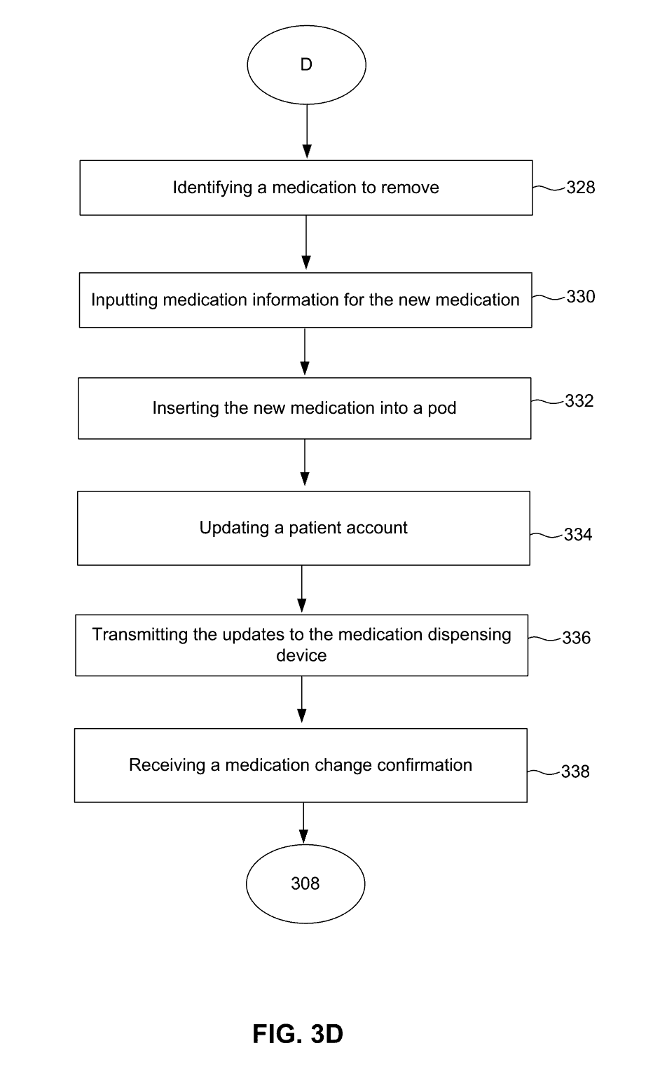

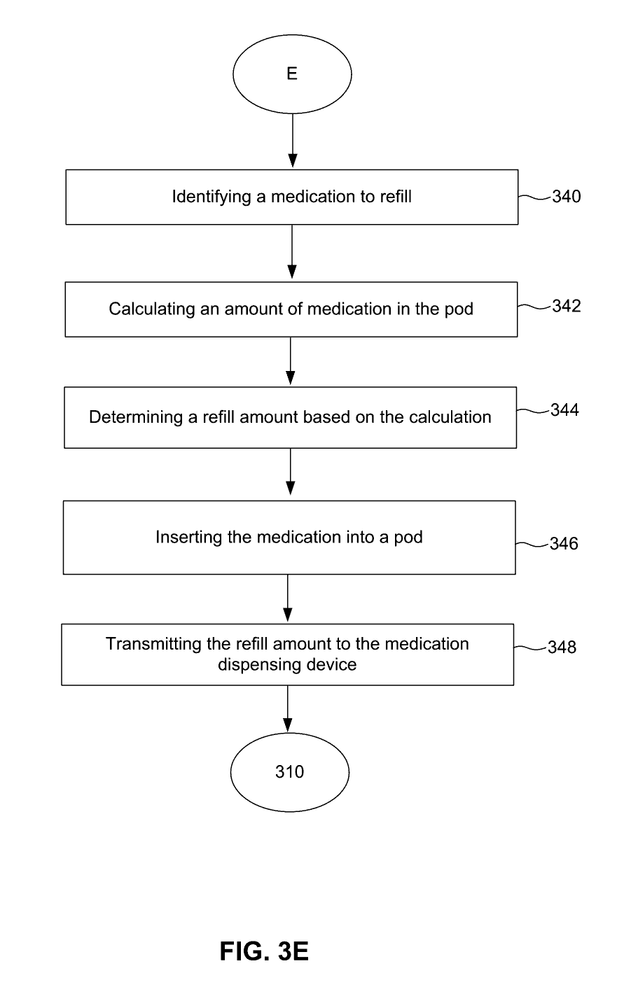

Referring now to FIGS. 3A-3E, illustrated therein is an example method flow 300 for managing a medication schedule for a patient in accordance with an aspect. The method may include accessing a medication schedule for a patient 302. The medication schedule for the patient may be accessed, for example, by a pharmacist through the pharmacy application 52 (FIG. 1). In an aspect, the pharmacist may use the pharmacy application 52 to access the patient account and identify the medication schedule for the patient.

The method may include determining whether a new medication should be added to the medication schedule for the patient in step 304 (FIG. 3A). For example, the pharmacist may determine that an additional medication has been added to a patient account. The pharmacist may receive prescription information from a doctor via written or electronic script, for example. In addition, the pharmacist may receive prescription information from the network 40 (FIG. 1) through the pharmacy application 52. The pharmacist may also receive the prescription information from the patient.

When a new medication is to be added to the medication schedule, the method may include inputting medication information for the new medication in step 312 (FIG. 3B). In an aspect, the pharmacist may use the pharmacy application 52 to update a patient account with the medication information for the new medication. The medication information may include, but is not limited to, a medication name, a prescribed medication mass, a dosage mass/weight, a dosage schedule for the medication, medication warning, instructions for taking the medication, and/or other properties of a medication into the patient account.

The method may also include inserting the new medication into a pod to be placed in a tray of the medication dispensing device in step 314. In an aspect, a pod may also be referred to as a medication container. The pharmacist may place the correct dosage of the new medication into the pod. In an aspect, the pharmacist may use the pharmacy application 52 to update the patient account with the amount of medication added to the pod (e.g., 30 pills added to the pod). In addition, the pharmacist may use the pharmacy application 52 to update the patient account with a serial number of the pod, or any other form of pod identifier, so that server 42 may identify which pod includes the new medication.

The method may also include transmitting the medication information and the pod identifier to the medication dispensing device in step 316. For example, pharmacy application 52 may access the medication dispensing device identifier associated with the patient account and transmit the medication information and the pod identifier for the new medication to medication dispensing device 20.

The method may also include receiving a medication added confirmation in step 318. In an aspect, pharmacy application 52 may receive a medication added confirmation signal transmitted from medication dispensing device 20. For example, when a patient or other user loads the pod into the tray identified for the new medication into the medication dispensing device 20, the medication dispensing device 20 may transmit a signal back to the server 42 confirming that the medication pod has been added to medication dispensing device 20, and the server 42 may transmit the medication added confirmation back to pharmacy application 52.

The method may proceed to step 304 and may determine whether any additional medication should be added to the medication schedule for the patient.

If no additional medications should be added to the medication schedule, the method may include determining whether any medications should be removed from the medication schedule for the patient in step 306 (FIG. 3A). For example, the pharmacy application 52 may indicate that a prescription for a patient may have ended for a particular medication and/or a medication has been removed from the medication schedule for the patient. The pharmacy application 52 may receive an indication from server 42 that a patient account has been updated to remove a medication from the patients' medication schedule. In addition, the pharmacist may receive a notice from a medical provider indicating that a medication should be removed from the medication schedule for the patient.

The method may include identifying a medication to be removed from the medication schedule of the patient in step 320 (FIG. 3C). For example, the pharmacist may use the pharmacy application 52 to identify a medication to be removed from the medication schedule of the patient. In addition, pharmacy application 52 may access the patient account to identify the pod and/or tray identifier associated with the medication to be removed from the patient's medical schedule.

The method may also include updating a patient account in step 322. The patient account may be updated to include the removal of the medication from the patient dosage schedule. In addition, the patient account may be updated to remove the pod from the tray identifier corresponding to the medication being removed from the patient's medical schedule and/or to indicate that the tray identifier should no longer be used in the medication dispensing device associated with the patient. For example, the pharmacist may use the pharmacy application 52 to update the patient account.

The method may also include transmitting the updates to the medication dispensing device in step 324. For example, the pharmacy application 52 may access medication dispensing device 20 associated with the patient account and transmit the medication updates to medication dispensing device 20. Medication dispensing device 20 may prompt a patient via user interface 22 (FIG. 1) to remove the identified medication from medication dispensing device 20.

The method may also include receiving a medication removal confirmation from the medication dispensing device in step 326. The pharmacy application 52 may receive a medication removal confirmation signal transmitted from medication dispensing device 20. For example, when a patient removes the pod associated with the identified medication to be removed, medication dispensing device 20 may transmit a signal back to server 42 confirming that the medication pod has been removed from medication dispensing device 20. Server 42 may transmit the medication removal confirmation back to pharmacy application 52.

The method may return to step 306 (FIG. 3A) and may determine whether any additional medications should be removed from the medication schedule of the patient.

If no additional medications should be removed, the method may include determining whether a medication should be changed in the medication schedule in step 308. If a medication should be changed for the medication schedule of the patient, the method may include identifying a medication to remove from the patient's dosage schedule in step 328 (FIG. 3D). For example, the pharmacist may use the pharmacy application 52 to identify a medication to be removed from the medication schedule of the patient. In addition, pharmacy application 52 may access the patient account to identify the tray identifier associated with the medication to be removed from the patient's medical schedule.

The method may also include inputting medication information for the new medication in step 330. In an aspect, the pharmacist may use the pharmacy application 52 to update a patient account with the medication information for the new medication.

The method may include inserting the new medication into a pod to be placed in a tray of the medication dispensing device in step 332. The pharmacist may place the correct dosage of the new medication into the pod. In an aspect, the pharmacist may use the pharmacy application 52 to update the patient account with the amount of medication added to the pod (e.g., 30 pills added to the pod). In addition, the pharmacist may use the pharmacy application 52 to update the patient account with a serial number of the pod, or any other suitable form of pod identifier as well as a tray identifier, so that server 42 may identify which tray includes the new medication pod. In an aspect, the tray identifier may be selected by the pharmacist using the pharmacy application 52, or the medication dispensing device 20 may select the tray identifier and provided the selected tray identifier to the pharmacy application 52.

The method may also include updating a patient account 334. For example, the pharmacist may use the pharmacy application 52 to update the patient account. The patient account may be updated to include the removal of the medication from the patient dosage schedule. In addition, the patient account may be updated to remove the pod identifier corresponding to the medication being removed from the patient's medical schedule and/or to indicate that the pod identifier should no longer be used in the medication dispensing device associated with the patient. In addition, the pharmacist may use the pharmacy application 52 to update the patient account with the amount of medication added to the pod (e.g., 30 pills added to the pod). In addition, the pharmacist may use the pharmacy application 52 to update the patient account with a serial number of the pod, or any other suitable form of pod identifier, so that server 42 may identify which pod includes the new medication.

The method may additionally include transmitting the updates to the medication dispensing device in step 336. For example, pharmacy application 52 may access the medication dispensing device identifier associated with the patient account and transmit the updates to medication dispensing device 20. The medication dispensing device 20 may prompt a patient via user interface 22 of the medication that should be removed and the medication that should be added to the medication dispensing device 20.

The method may also include receiving a medication change confirmation from the medication dispensing device in step 338. The pharmacy application 52 may receive a medication change confirmation signal transmitted from medication dispensing device 20. For example, when a patient removes the pod associated with the identified medication to be removed, medication dispensing device 20 may transmit a signal back to server 42 confirming that the medication pod has been removed from medication dispensing device 20. In addition, when the patient adds the pod associated with the new medication, medication dispensing device 20 may transmit a signal back to server 42 confirming that the medication is added. Server 42 may transmit the medication change confirmation back to pharmacy application 52.

The method may proceed to step 308 (FIG. 3A) and may determine whether any additional medications should be changed for the medication schedule.

If no additional medications should be changed, the method may proceed to step 310 and may include determining whether any medication should be refilled for the patient. If a medication should be refilled for the patient, the method may include identifying a medication to refill in step 340 (FIG. 3E). For example, a pharmacist may use pharmacy application 52 to identify which medications may need to be refilled. The pharmacy application 52 may receive a notification from medication dispensing device 20 indicating that a medication may need to be refilled. In addition, the pharmacy application 52 may receive a notification from server 42 indicating that a medication may need to be refilled.

The method may also include calculating an amount of medication in a pod in step 342. In an aspect, server 42 may receive a mass/weight calculation from medication dispensing device 20 for the medications in the tray. For example, server 42 may identify the pod and tray associated with the medication that should be refilled and may query medication dispensing device 20 for the mass/weight of the medication remaining in the identified pod. Medication dispensing device 20 may measure the mass/weight of the medication based on a received data input from the output of a corresponding load cell, strain gauge, scale, or other measurement device, for example. The input from the load cell may include a mass/weight of the pod. Medication dispensing device 20 may transmit the measured mass/weight to server 42. Server 42 may receive the measured mass/weight of the trays pods and calculate a quantity of medication remaining in the pod by, for example, subtracting the measured mass/weight of a tray and pod from the total mass/weight of the tray plus the prescribed medicine. Server 42 may use the results to determine a quantity of medication remaining in the tray. In an aspect, the reading from the load cell may include only the mass/weight of the medication in the medication pod. In another aspect, medication dispensing device 20 may calculate an amount of medication remaining in the pod and transmit the calculated amount to server 42. Pharmacy application 52 may receive the calculated amount of medication remaining in the pod from server 42 via network 40, for example.

The method may include determining a refill amount of medication based on the calculation in step 344. In an aspect, pharmacy application 52 may determine an amount of medication to refill based on the calculated amount of medication remaining in the pod. The pharmacist may have real-time visibility into the medication remaining in the pod and may be able to refill the medication with only an amount required to provide a quantity sufficient fill. For example, if a prescription is for 30 pills and the system calculates that 5 pills are still remaining in the pod, the system may determine that the amount of medication to refill should be 25 pills. By adjusting the amount of medication to refill based on the amount of medication remaining in the pod or tray, the system may provide a quantity sufficient fill of the medication to the patient to ensure that the patient has an adequate supply of medication, without providing excess medication. In addition, by adjusting the refill based on the amount of medication remaining in the pod, the pharmacist may synchronize the refills to occur on the same date so that the patient may refill multiple medications on the same day without having to wait for each medication to be near completion.

The method may include inserting the refill amount of medication into a pod in step 346. The pharmacist may place the correct dosage of the refill into the pod. In an aspect, the pharmacist may use the pharmacy application 52 to update the patient account with the amount of medication refilled in the pod. In addition, the pharmacist may use the pharmacy application 52 to update the patient account with a serial number of the pod, or any other form of pod identifier, so that server 42 may identify which pod includes the refilled medication.

The method may also include transmitting the refill amount to the medication dispensing device in step 348. The refill amount may include an amount of medication refilled for the patient. For example, the pharmacy application 52 may transmit the pod identifier and the amount of medication refilled for the patient to medication dispensing device 20 via network 40, for example.

As such, the system may be used to manage the medication schedule of the patient.

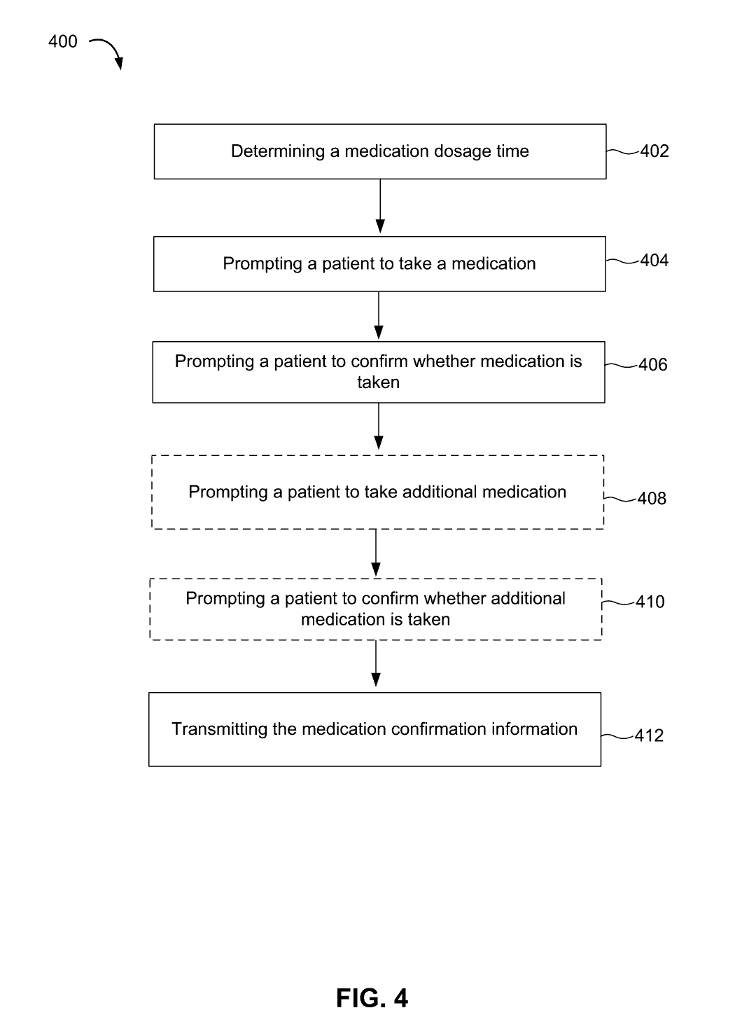

Referring now to FIG. 4, illustrated therein is an example method flow 400 for prompting a patient to take medicine in accordance with an aspect. The method may include determining a medication dosage time in step 402. In an aspect, medication dispensing device 20 (FIG. 1) may access the medication information received from the pod identifier information, the pharmacy application 52 and/or server 42 to determine a dosage time for the medication. For example, medication dispensing device 20 may determine that a patient needs to take two medications in the morning based on the medication information received for the patient.

The method may also include prompting a patient to take a medication in step 404. For example, medication dispensing device 20 (FIG. 1) may prompt a patient through user interface 22 (FIG. 1) to take a medication. User interface 22 may display, for example, the time of day, a meal associated with the time of day (e.g., breakfast, lunch, dinner), the name of the medication, the purpose of the medication, a dosage amount of the medication, a picture of the medication, any instructions for taking the medication (e.g., take with food), medication details, an amount of medication previously taken, and when a next dose of medication is due. User interface 22 may include an initial interface (e.g., a home screen interface) that may be presented when the patient activates medication dispensing device 20. The initial interface may include, for example, a clock, upcoming medication dosage information, health and wellness information, goals, progress to goals, settings icon, a travel icon, a medication icon, and a banner message. The banner message may be a multipurpose message area where various notifications are presented to the patient, such as but not limited to, upcoming appointments, changes to any upcoming appointments, and an amount of time to the next medication dosage.

In an aspect, an interface on the outside of medication dispensing device 20 (FIG. 1) may present a reminder to the patient to take a medication. In another aspect, user interface 22 may present a reminder to the patient to take a medication. In another aspect, medication dispensing device 20 may transmit an audible reminder to the patient to take a medication. For example, when a patient approaches medication dispensing device 20, medication dispensing device 20 may detect the motion of the patient and send an audible reminder to the patient to take a medication. Also, when the patient activates user interface 22, for example, by selecting a button and/or touching user interface 22, medication dispensing device 20 may send an audible reminder to the patient to take a medication. Audible reminders may include, but are not limited to, recorded messages, alarms, personalized voice messages, and sounds. An administrator, such as a pharmacist and/or patient may select preferences for the audible reminders when setting up medication dispensing device 20. For example, the administrator and/or patient may record a message, select a prerecorded message, select an alarm, and/or may select a default setting for the audible reminders. In addition, the patient may change a setting for the audible reminders at any time. In an aspect, medication dispensing device 20 may also present visual reminders to the patient to take a medication. Visual reminders may include, for example, illuminating various lights (e.g., LED) on medication dispensing device 20.

In addition, medication dispensing device 20 may transmit a message to a cellular telephone or other device associated with the patient, prompting the patient to take a medication. For example, medication dispensing device 20 may be paired to a patient's cellular telephone and/or other devices and may call, e-mail, and/or send a text message to the cellular telephone or other devices with a message notifying the patient that it is time to take one or more medications.

Medication dispensing device 20 may allow the correct tray to be accessed so that the patient can remove the correct dosage of medication from a particular pod at the appropriate time. Medication dispensing device 20 may also allow the patient to take a next dose early. For example, the patient may use user interface 22 to select the next dose of medication and medication dispensing device 20 may dispense the next dosage of medication for the patient (for example, if a patient will be travelling and will not have access to the device 20 at the next dosage time).

In an aspect, medication dispensing device 20 may determine that the patient removed too many or too few pills from the medication pod. For example, medication dispensing device 20 may compare the weight of the medication dispensing tray or pod prior to a dosage time against an expected value of the medication tray or pod after the dosage time or after the device 20 determines that a tray has been moved into a medication accessible position. When a discrepancy exists in the comparison, the medication dispensing device 20 may determine that the patient removed an incorrect amount of medication from the medication pod. Upon determining that the patient removed an incorrect amount of medication from the medication pod, medication dispensing device 20 may transmit an alert and/or notification in real-time to the patient regarding the incorrect dosage amount. For example, medication dispensing device 20 may present a message on user interface 22 notifying the patient of the incorrect dosage amount with instructions to the patient for fixing the dosage amount (e.g., please take additional medication or please do not take and replace the additional medication removed from the medication pod). In addition, medication dispensing device 20 may transmit an audible alarm to the patient notifying the patient of the incorrect dosage amount. In an aspect, the alert and notification will be transmitted to the patient before the patient ingests the incorrect amount of medication. In an aspect, the message queries the patient as to whether the patient purposefully removed excessive medication. In another aspect, the patient's doctor, pharmacist, or caregiver will be alerted if the device 20 detects that an excessive amount of medication has been removed.

The method may also include prompting a patient to confirm whether the medication has been taken 406. For example, user interface 22 may have an icon and/or button the patient may select confirming that the medication has been taken. In addition, user interface 22 may have an icon or button allowing the patient to skip taking a dose of the medication. If the patient skips the dose of the medication, user interface 22 may prompt the patient to select a reason why the dose was skipped. For example, the patient may indicate that the medication will be taken at a later time, the patient is out of the medication, the medication is causing uncomfortable side effects, or the patient does not want to take the medication.

The method may optionally include prompting a patient to take additional medication in step 408. Additional medication may include, for example, other medication not dispensed by the medication dispensing device, such as insulin and liquid solutions. For example, user interface 22 may prompt a user to take any additional medication. User interface 22 may display the name of the medications, a dosage amount of the medication, a picture of the medications, any instructions for taking the medication (e.g., take with food), and medication details.

Optionally, the method may include prompting a patient to confirm whether the additional medication has been taken 410. For example, user interface 22 may have an icon and/or button the patient may select confirming that the additional medication has been taken. In addition, user interface 22 may have an icon and/or button allowing the patient to skip the additional medication. If the patient skips the medication, user interface 22 may prompt the patient to select a reason why the medication was skipped.

The method may also include transmitting medication confirmation information in step 412. For example, medication dispensing device 20 may transmit the medication confirmation information to server 42 via, for example, network 40.

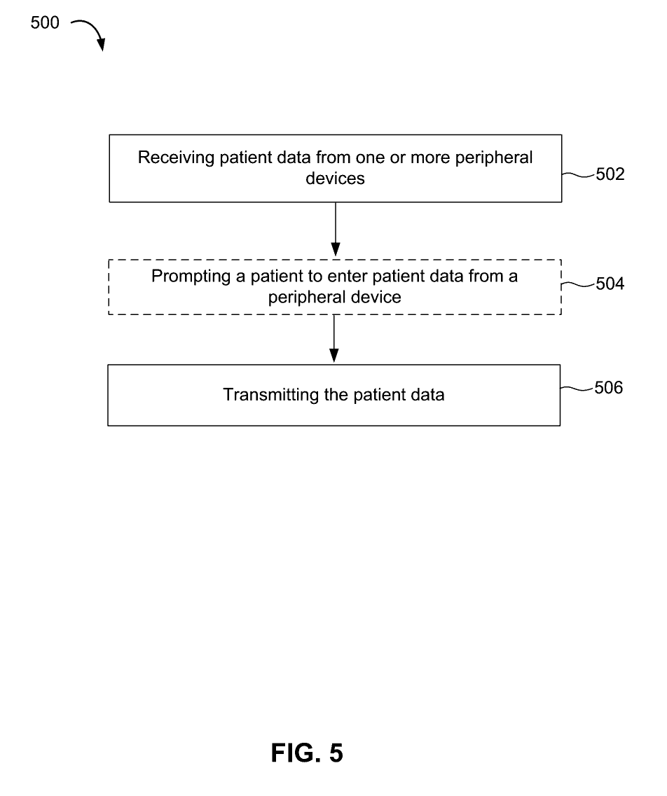

Referring now to FIG. 5, illustrated therein is an example method flow 500 for gathering information from peripheral devices in accordance with an aspect. The method 500 may include receiving patient data from one or more peripheral devices in step 502. Peripheral devices may be any suitable device that may obtain medical or biometric data from a patient. For example, peripheral devices may be a glucometer, cardiac monitor, thermometer, respiratory monitor, sleep monitor, pulse oximeter, body scale, inhaler, nebulizer, fitness tracker, blood pressure cuff, syringe, stethoscope, breathalyzer, mobile phone sensor, etc. In an aspect, peripheral devices 24 (FIG. 1) may be connected to medication dispensing device 20 (FIG. 1) through a wired (e.g., universal serial bus (USB) connection or a wireless (e.g., Bluetooth) connection. Peripheral devices 24 may be synchronized to medication dispensing device 20 so that any measurements or biometric data collected by peripheral devices 24 may be automatically transmitted to medication dispensing device 20. Medication dispensing device 20 may in turn transmit the measurements or biometric data to server 42 and/or other devices via network 40.

The method may optionally include prompting a patient to enter patient data from a peripheral device in step 504. Patient data may include medical or biometric data, as well as patient demographic data. Peripheral devices 24 may include devices that are not connected to medication dispensing device 20 and the patient may enter measurements and/or other readings taken by the peripheral device using user interface 22. Example peripheral devices not connected to the medication dispensing device may include, but are not limited to, scales and a blood pressure cuff. User interface 22 may prompt a patient to enter patient data from one or more peripheral devices 24 not connected to medication dispensing device 20. For example, the user interface may prompt a user to enter the patient's weight.

The method may also include transmitting the patient data in step 506. For example, medication dispensing device 20 may transmit the patient data, measurements, and/or biometric data received from peripheral devices 24 and/or the patient to server 42 via the network 40. The device 20 or server 42 may use the received patient data, for example, to identify which peripheral devices 24 are being used by the patient, determine whether the patient data is within acceptable ranges for the disease state of the patient, determine the frequency in which the patient is using the peripheral devices, and a time of day in which the patient uses the peripheral devices.

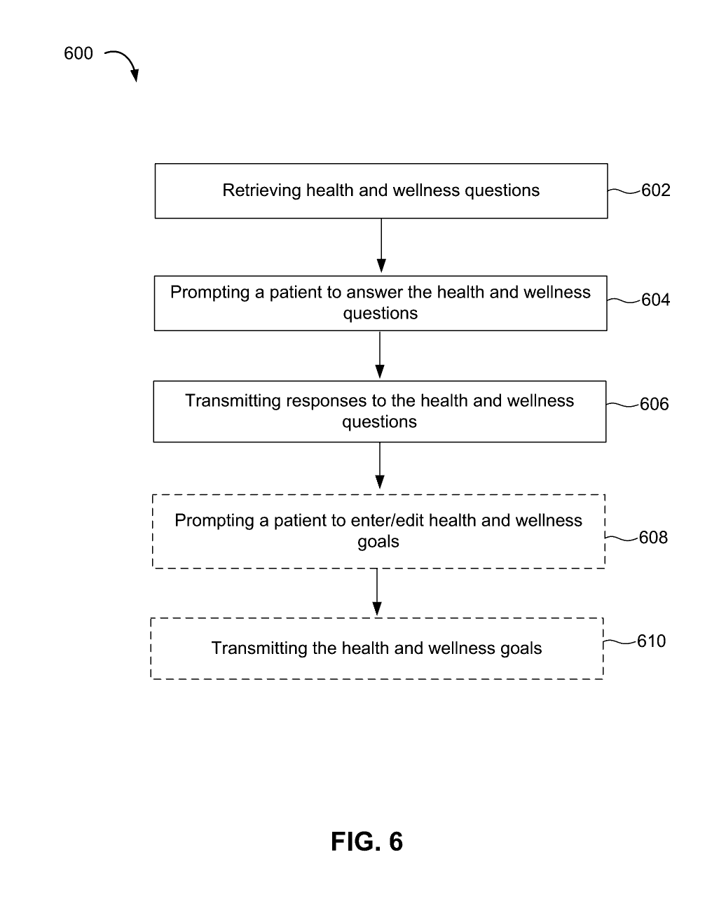

Referring now to FIG. 6, illustrated therein is an example method flow 600 for gathering health and wellness information in accordance with an aspect. The method 600 may include retrieving health and wellness questions in step 602. In an aspect, server 42 may transmit one or more health and wellness questions to medication dispensing device 20. Medication dispensing device 20 may present the health and wellness questions to the patient via, for example, user interface 22. In another aspect, the health and wellness questions may be transmitted to a cellular telephone and/or other device associated with the patient. The health and wellness questions may include subjective questions about the patient's health and wellness. For example, the health and wellness questions may include self diagnostic questions relating to the patient's mood, side effects of the medications, problems, and/or symptoms the patient may be experiencing (e.g., How are you feeling?). In addition, the health and wellness questions may include reporting questions (e.g., How did you sleep last night?).

The method may also include prompting a patient to answer the health and wellness questions in step 604. For example, the user interface 22 (FIG. 1) of the medication dispensing device 20 (FIG. 1) may prompt the patient to answer one or more health and wellness questions. The patient may elect to answer the health and wellness questions. In an aspect, the patient may select an option to answer the questions at a later time and/or skip answering the questions. If the patient selects to answer the questions at a later time and/or skip answering the questions, the method 600 may end.

In addition, the method may include transmitting responses to the health and wellness questions in step 606. For example, medication dispensing device 20 may transmit the responses received to the health and wellness questions to server 42 via network 40.

Optionally, the method may include prompting a patient to enter and/or edit health and wellness in step 608. User interface 22 may prompt the patient to enter one or more health and wellness goals. In addition, the patient may use user interface 22 to edit one or more health and wellness goals. For example, the patient may edit and/or remove an existing health and wellness goal.

The method may also optionally include transmitting the health and wellness goals in step 610. For example, medication dispensing device 20 may transmit the health and wellness goals to server 42 via network 40.

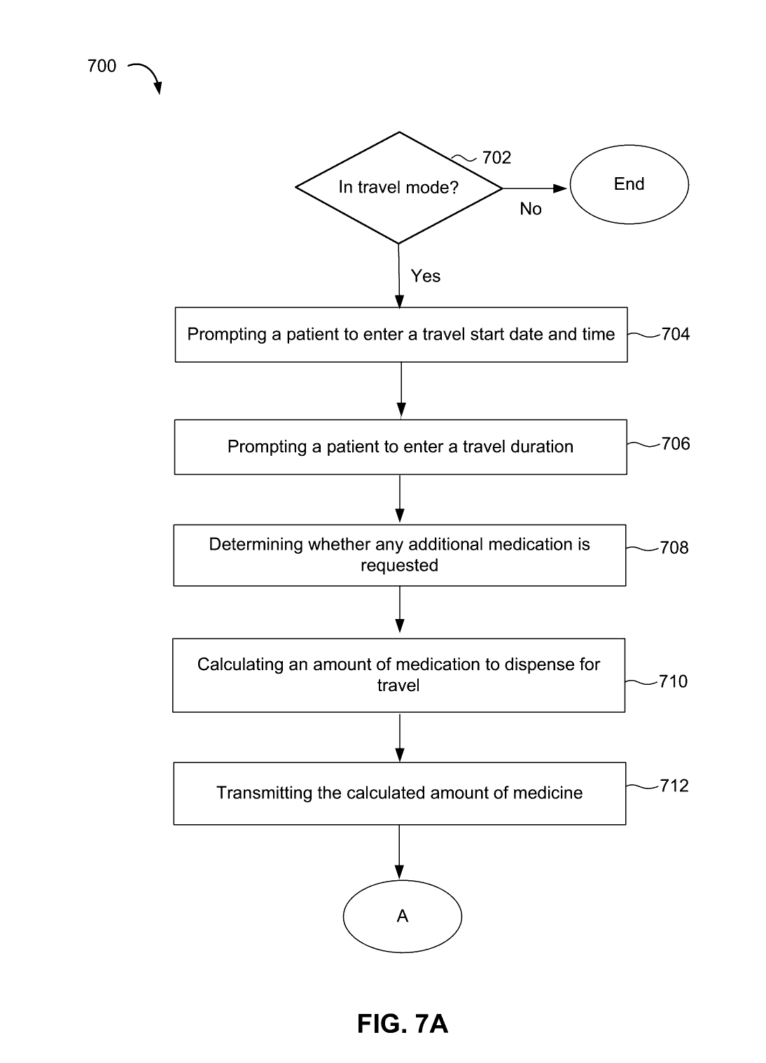

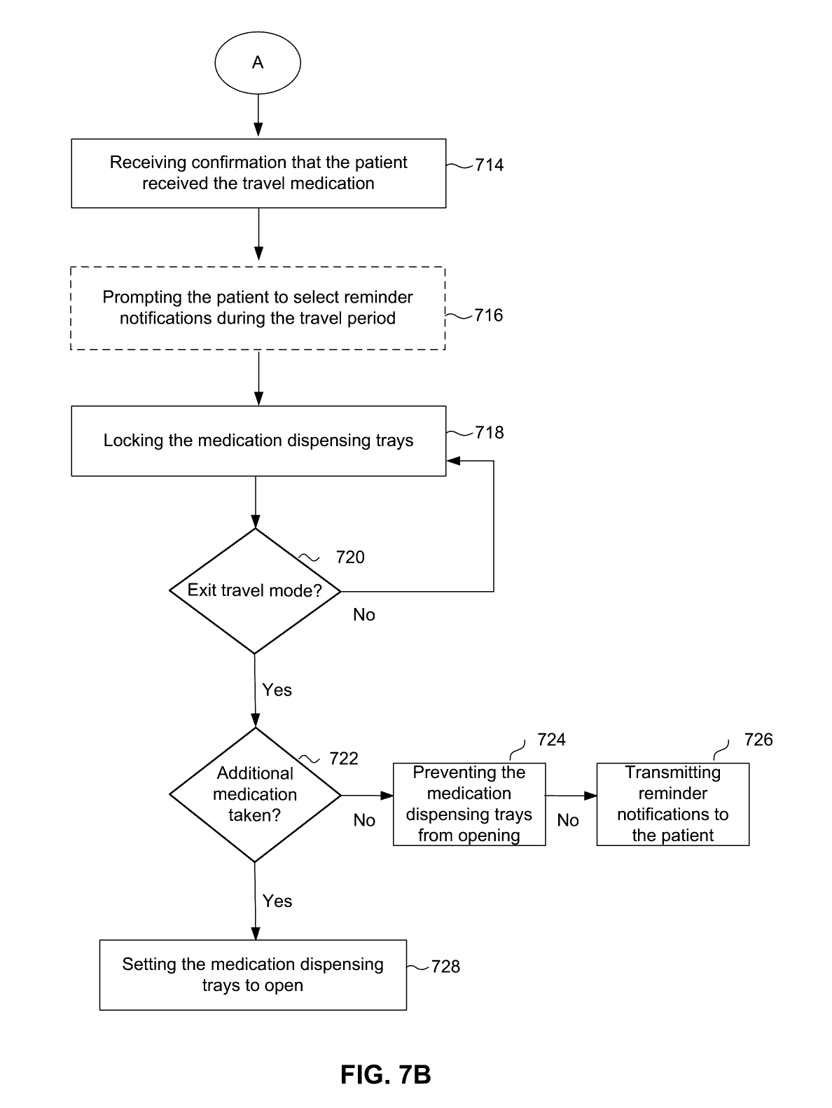

Referring now to FIGS. 7A and 7B, illustrated therein is an example method flow 700 for establishing a travel mode in accordance with an aspect. The method 700 may include determining whether a travel mode is selected in step 702. For example, user interface 22 on medication dispensing device 20 may prompt a patient to schedule upcoming travel so that medication dispensing device 20 may dispense any medications required while the patient is travelling. The patient may select to schedule travel or select to not schedule travel.

When the patient selects to schedule travel, the method may include prompting a patient to enter a travel start date and time 704. For example, user interface 22 may prompt a patient to enter a start date and time. The patient may select the start date, for example, by clicking on a calendar, selecting a date from a pre-populated list of dates, or entering in the start date on user interface 22. In addition, the patient may select the start time by selecting a time on a clock, selecting the time from a pre-populated list of times, or entering in the start time on user interface 22. For example, the patient may enter in the start date and/or time using a keyboard displayed on user interface 22, speaking the start time, or using any other input mechanism.

The method may also include prompting a patient to enter a travel duration in step 706. For example, user interface 22 may prompt the patient to enter in the travel duration. The patient may select the duration, for example, from a list of days and/or a calendar. In addition, the patient may enter in the travel duration using a keyboard displayed on user interface 22, speaking the duration (e.g., voice recognition input), or using any other input mechanism.

In addition, the method may include determining whether additional medication is requested in step 708. For example, user interface 22 may prompt a patient to select whether any additional medication is requested to cover a delay in travel. The patient may select, for example, no additional medication and/or a number of days of additional medication.

The method may also include calculating an amount of medication to dispense for travel in step 710. In an aspect, medication dispensing device 20 may calculate an amount of medication to dispense to the patient for the travel duration. For example, medication dispensing device 20 may access the medication dosage schedule for the patient and multiply the medication dosage schedule for the travel duration. Next, medication dispensing device 20 may add any additional medication requested by the patient.

The method may further include transmitting the calculated amount of medication in step 712. For example, medication dispensing device 20 may transmit the calculated amount of medication to server 42 via, for example, network 40. In addition, medication dispensing device 20 may transmit the calculated amount of medication to a processor that controls the dispensing of the medication for medication dispensing device 20 so that medication dispensing device 20 may initiate the medication dispensing. In an aspect, the patient may use a pill organizer to organize the medication dispensed for travel. The user interface 22 may present a thumb nail view of the pill organizer illustrating where the dispensed medications should be placed in the pill organizer.

The method may also include receiving confirmation that the patient received the travel medication in step 714. For example, user interface 22 may prompt the patient to confirm that the patient received the travel medication by, for example, selecting a button to confirm.

Optionally, the method may include prompting a patient to select reminder notifications during the travel period in step 716. User interface 22 may prompt a user to select one or more notification methods for receiving dispensing reminders while travelling. For example, the patient may select to be notified via e-mail message, text message, and/or telephone calls of upcoming medication dosages. In an aspect, medication dispensing device 20 may use a setting previously selected by the patient for the dispensing reminders.

The method may also include locking the medication dispensing trays during the travel period in step 718. Medication dispensing device 20 may lock the medication dispensing trays during the travel period so additional medications may not be dispensed during the designated travel period. By locking the medication dispensing trays, medication dispensing device 20 (FIG. 1) may prevent extra medication accessed by the patient or another individual.

In addition, the method may include determining whether to exit the travel mode in step 720. Medication dispensing device 20 may determine that the travel dates selected have ended and user interface 22 may prompt the patient to exit the travel mode. For example, user interface 22 may present to the patient a welcome back message allowing the patient to reengage the medication dispensing device 20 by selecting, for example, a button and/or an icon. If the patient selects to not exit the travel mode, the method may proceed to 718 where the medication dispensing trays may remain locked.

When the patient selects to exit the travel mode, the method may include determining whether the patient has taken all of the additional medication removed by the patient for the travel period in step 722. Medication dispensing device 20 may determine if any additional medication was removed by the patient. If so, user interface 22 (FIG. 1) may prompt the patient to confirm whether all of the additional medication has been consumed by the patient.

If the patient indicates that the additional medication has not been consumed, the method may include preventing the medication trays from opening in step 724. Medication dispensing device 20 may keep the medication dispensing trays locked until the patient confirms that the additional medication has been consumed by the patient. Thus, an excess of medication may be prevented from being dispensed to the patient.

The method may also include transmitting reminder notifications to the patient to take medications in step 726. In an aspect, user interface 22 may provide reminder notifications to the patient of upcoming medication dosages. In addition, medication dispensing device 20 may transmit the reminder notifications to the patient, for example, via e-mail message, text message, and/or telephone calls.

When the patient indicates that all of the additional medication has been taken, the method may include allowing the medication trays to open in step 728. Medication dispensing device 20 may reengage the dispensing trays to open based on the medication dosage time for the patient.

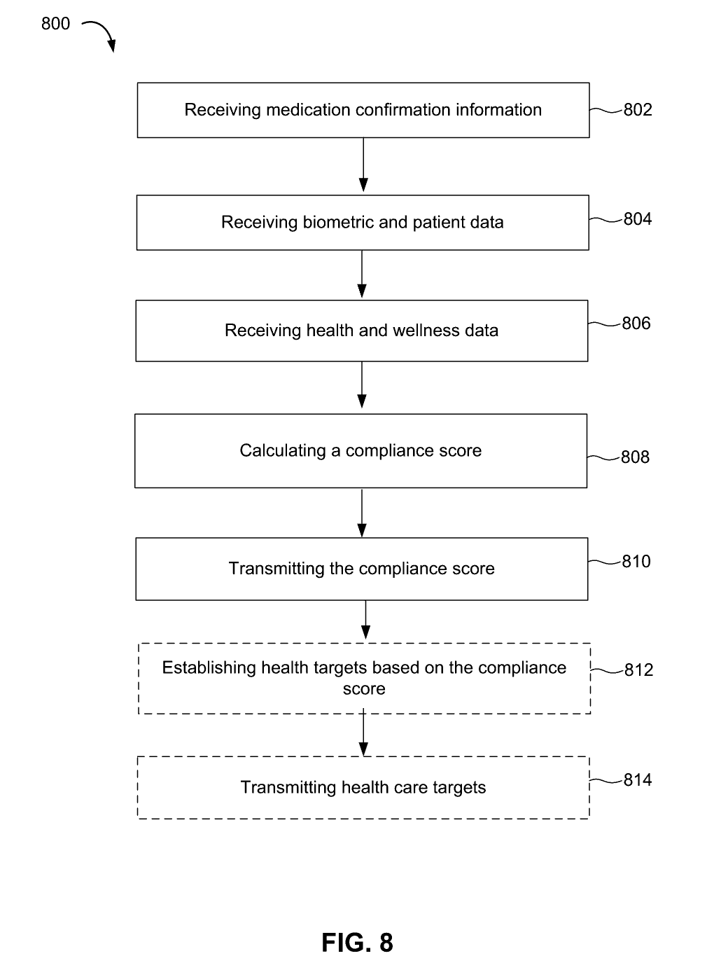

Referring now to FIG. 8, illustrated therein is an example method flow 800 for calculating a dose compliance and dose adherence scores in accordance with an aspect. The medication dispensing device includes a memory that stores a patient's dose schedule along with detailed analytic information about the patient's pill-consuming activity over a chosen period of time, such as a day, week, month or year. This information includes an overall number of doses of a particular type of pill taken, whether the particular dose was compliant, whether the particular dose was adherent, and readings from a peripheral device 24 coinciding with dose times. A sample dose schedule for a patient is shown in Table 1, and a sample medication consumption report for the patient is shown in Table 2. Within Table 2, the patient's consumption for Monday reflects 100% compliance and adherence, whereas the consumption for Tuesday reflects less than complete compliance and adherence.

TABLE 1
PATIENT: JANE DOE, FEMALE, AGE 65

| | | Morn- | After- | | |
|---|---|---|---|---|---|
| Name | Directions | ing | noon | Night | Total |
| Medication A | Take once daily | 1 | | | 1 |
| Medication B | Take once daily | 1 | | | 1 |
| Medication C | Take twice daily | | 1 | 1 | 2 |
| Medication D | Take two pills twice | | 2 | 2 | 4 |
| | daily | | | | |
| | Total by Dose | 2 | 3 | 3 | 8 |
| | Window | | | | |

TABLE 2
PATIENT: JANE DOE, FEMALE, AGE 65

| | Monday, Apr. 4, 2016 | | | | | Tuesday, Apr. 5, 2016 | | | | |
|---|---|---|---|---|---|---|---|---|---|---|
| | Mor. | Noon | Night | Other | Total | Mor. | Noon | Night | Other | Total |
| Med. A | 1 | | | | 1 | 2 | | | 1 | 3 |
| Med. B | 1 | | | | 1 | 1 | | | | 1 |
| Med. C | | 1 | 1 | | 2 | | 2 | 0 | | 2 |
| Med. D | | 2 | 2 | | 4 | | 1 | 1 | | 2 |
| | 2 | 3 | 3 | 0 | 8 | 3 | 3 | 1 | 1 | 8 |

| | |
|---|---|
| Dose Compliance: 4 of 4 | Dose Compliance: 2 of 4 |
| Dose Adherence: 8 of 8 | Dose Adherence: 5 of 8 |
| Dose Excess: 0 | Dose Excess: 2 |

Dose compliance measures a patient's consumption of a medication irrespective of when during the day the medication was taken. For example, using Tables 1-2, if a patient is prescribed Medication C to be taken two times per day (see Table 1), and the patient properly consumes two pills per day (see row for Medication C on Monday in Table 2), then that patient is considered 100% compliant for that day. The patient is 100% compliant the day even if both pills were consumed at the same time (see row for Medication C on Tuesday in Table 2). Dose adherence is a more specific metric than dose compliance and measures a patient's consumption of a medication within particular timeframes as determined by a medical care provider working with the patient. For example, if the patient from the previous example is prescribed Medication C to be taken two times per day with once each in the afternoon and nighttime (Table 1), the patient is considered 100% adherent only if the medication is consumed within pre-assigned dose time windows associated with the afternoon and nighttime (see row for Medication C on Monday in Table 2). If the patient consumes the day's two pills all in the afternoon window (see row for Medication C on Tuesday in Table 2), then only partial adherence is achieved (adherent in the afternoon window and non-adherent in the nighttime window). Doses taken outside of a pre-assigned dose window count towards computing compliance and may be reflected in an “Other” column in Table 2.

In Table 2, the overall compliance is measured out of 4, reflecting the consumption of the prescribed daily number of pills of Medications A-D, respectively. Accordingly, the patient's dose compliance on Tuesday in Table 2 is shown as ¼ because the patient consumed the correct number of pills for only Medications B and C on that day. Dose Adherence in Table 2 is measured out of 8, reflecting 8 total pills that must be consumed in a day in specific dose windows. The patient's dose adherence on Tuesday in Table 2 is shown as only ⅝ because the patient consumed: 1) one medication A in the morning, 2) one medication B in the morning, 3) one medication C in the afternoon, 4) one medication D in the afternoon, and 5) one medication D at nighttime. The remaining ⅜ for adherence reflects missed doses of 1) medication C at nighttime, 2) medication D in the afternoon, and 3) medication D at nighttime. Excess doses are reflected in a Dose Excess score (in Table 2 on Tuesday an extra dose of medication A each in the morning and in an “other” dose window).

As shown in Table 2, a patient's adherence and compliance with multiple medications can be individually tracked by each dose window over a period of time, in this case two days during the month of April 2016. The information presented in report like that of Table 2 may be valuable to care givers. For example, a version of Table 2 extrapolated over an entire month may show that the patient consistently missed doses of Medication C, but was consistently adherent with doses of Medication B. The patient's physician may then question the patient as to the reasons for the missed doses of Medication C as opposed to Medication B, perhaps because of a side effect, difficulty in swallowing, costs of the medication, or other factors. Accordingly, the physician can alter the prescribed dosage of Medication C to increase compliance and adherence.

Returning to FIG. 8, in step 802, the device 20 or server 42 may receive medication information from medication dispensing device 20 indicating the times doses of medication were dispensed by the device or accessed by the patient, the quantity of pills that were dispensed/accessed during each dose window, and any doses that were missed or skipped.

The method may also include receiving biometric data and patient data in step 804. In an aspect, server 42 may receive biometric data and/or patient data from medication dispensing device 20 and/or peripheral devices 24.

In addition, the method may include receiving health and wellness data in step 806. For example, server 42 may receive data inputted by the patient to the medication dispensing device 20 shortly before or after accessing a dose of medication. This data may indicate general mood (e.g., alert, tired, sleepy, hungry) or a current health and wellness conditions (e.g., upset stomach, dizziness, nausea, headache/body ache).

The method may further include calculating a compliance and adherence score based on a medication dosage schedule for a patient in step 808. The compliance score may indicate a percentage reflecting a ratio of how many doses of medication were taken compared to a total number of prescribed doses for a given period of time. For example, if in a month a patient takes a once-daily medication 27 times out of 30 prescribed doses, the patient's compliance score would be 90%.

The adherence score may reflect a number of times a patient took a dose of medication within the allowed time window and whether the correct quantity of medication was consumed. For example, if in a month a patient takes a 3×-daily medication 72 times out of 90 times with the correct dose and within the allotted dose window, the compliance score may indicate that the patient had an 80% adherence with the medication dosage schedule.

In an embodiment, compliance and adherence scores of the patient may be aggregated over a period of time. For example, device 20 or server 42 may determine the compliance percentage of the patient over 100 days or a year. The device 20 or server 42 may also calculate separate adherence and compliance scores for each medication consumed by a patient. The compliance or adherence calculation may also place a different weight or emphasis on different types of medication. For example, compliance with a critical blood pressure medication may have a greater impact on an overall compliance/adherence score than compliance with an optional nutritional supplement. The calculation may also place emphasis on medications to be taken at certain times of day, whether medications are prescription or over the counter, or those deemed critical to consume. The calculation may also take into account and be adjusted based on the degree to which other patients are compliant/adherent with the same type of medication or the same time of day. The calculation may be displayed in numerous ways: as a percentage, as on overall score, as a number of stars, as a letter grade (e.g., A, B, C, D, or F), thumbs up/down, or the like.

In an aspect, system 10 (FIG. 1) may calculate a compliance score for biometric data and/or patient data received by the system. For example, the system may calculate a number of times a patient took a blood pressure measurement out of a total regiment provided to the patient to determine the compliance score for a medical reading.

The method may include transmitting the compliance and adherence scores in step 810. For example, server 42 may transmit the compliance score to the medication dispensing device 20 or the device 20 may compute the compliance and adherence scores locally. The compliance and adherence scores of the patient may be sent anonymously (i.e., with protected health information (PHI) being removed) to a cloud-based storage, where the scores of many patients may be aggregated. These aggregated adherence and compliance scores may reveal valuable insight as to the factors that influence adherence and compliance (e.g., the times of day, the particular drug, side effects experienced by patient).

Medication dispensing device 20 may present the compliance and adherence scores to the patient via, for example, user interface 22. A patient may be able to view the compliance score in real time or at specified time periods (weekly, monthly, etc.). In addition, server 42 (FIG. 1) may transmit the compliance score to one or more devices and/or applications associated with the patient, caregivers, medical providers, and/or pharmacists. As such, caregivers, medical providers, and/or pharmacists may track when a medication was taken out of the medication dispensing device (e.g., a time stamp and date), evaluate a patient's compliance with the medication regimen, and monitor compliance with peripheral devices.

Optionally, the method may include establishing healthcare targets, for example, based on the compliance score in step 812. Healthcare targets may include a target percentage of medication compliance/adherence, a target blood pressure reading, and a target weight. In an aspect, server 42 may use the compliance/adherence scores, patient demographic data and/or health and wellness data received to establish healthcare targets for the patient.

The method may also optionally include transmitting the healthcare targets in step 814. For example, server 42 may transmit the healthcare targets to medication dispensing device 20. Medication dispensing device 20 may present the healthcare targets to the patient and may also present a metric indicating how the patient may be measuring up to the healthcare targets via, for example, user interface 22. Thus, a patient may view the healthcare targets and how well the patient may be measuring up to the healthcare target. In addition, user interface 22 may present suggestions and/or recommendations for improving the patient's metrics for the healthcare targets. For example, a patient may be able to access health newsletters, health articles, blogs, Internet websites, videos, recipes, etc., with recommendations and/or suggestions for improving the patient's metrics for the healthcare targets. In addition, server 42 may transmit the healthcare targets to one or more devices and/or applications associated with the patient, caregivers, medical providers, and/or pharmacists.

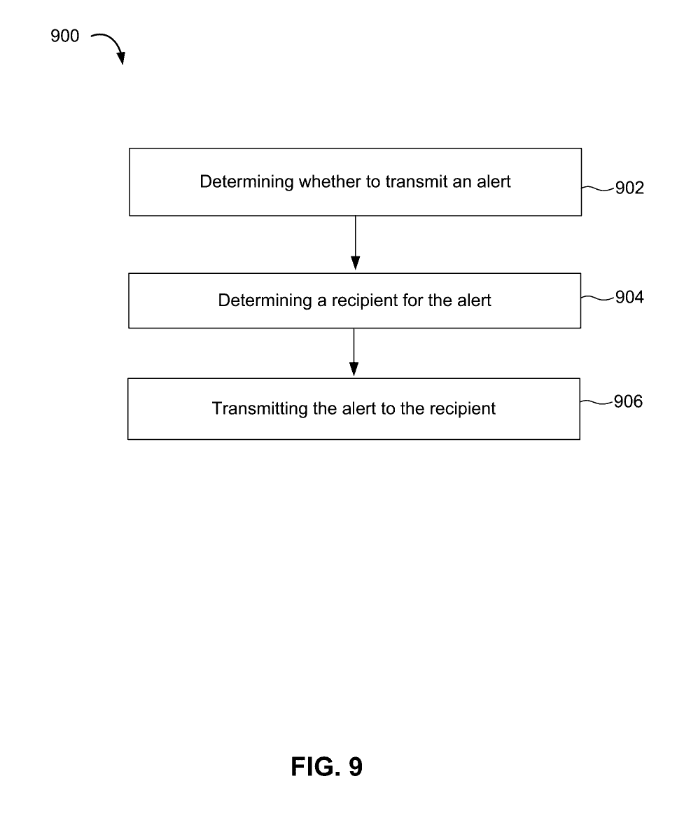

Referring now to FIG. 9, illustrated therein is an example method flow 900 for transmitting alerts in accordance with an aspect. The method 900 may include determining whether to transmit an alert in step 902. For example, the device 20 may determine or server 42 may receive one or more notifications indicating that an alert should be transmitted. Notifications may include, but are not limited to, error messages, medication dosage times, upcoming appointment reminders, missed medications, biometric readings in excess of a threshold level, biometric readings below a threshold level, measurements in excess of a threshold, measurements below a threshold level, medication refills notices, loss of medication, incorrect medication tray accessed, medication tray error, and incorrect medication dosage amount taken. Notifications may be transmitted to server 42 from medication dispensing device 20 (FIG. 1), for example. In addition, notifications may be transmitted to server 42 from one or more peripheral devices 24 (FIG. 1) associated with a patient. Notifications may also be generated by the server 42 based on calculations performed by the server 42 (FIG. 1), for example.

The method may also include determining a recipient for the alert in step 904. Recipients may include, but are not limited to, a patient, a caregiver, a medical provider, a family member, a pharmacist, a hospital, and a payer. In an aspect, server 42 may determine one or more recipients for receiving the alert based on the type of alert being transmitted and a reason for the alert. For example, if the biometric data received from a patient exceeds a recommend range and/or is below a recommended range, server 42 may determine that a medical provider should receive an alert based on the biometric data received. In addition, if the medical confirmation information indicates that the patient has missed several dosages of medication, server 42 may determine that an alert should be transmitted to a patient and a family member or caregivers of the patient.

In addition, the method may include transmitting the alert to the recipient in step 906. The alert may include the notification received and/or a customized message based on the notification. For example, server 42 may transmit the alert to medication dispensing device 20. In addition, server 42 may transmit the alert to a cellular telephone or other device associated with a patient, caregiver, family member, or medical provider of the patient. Server 42 may also transmit the alert to pharmacy application 52 (FIG. 1).

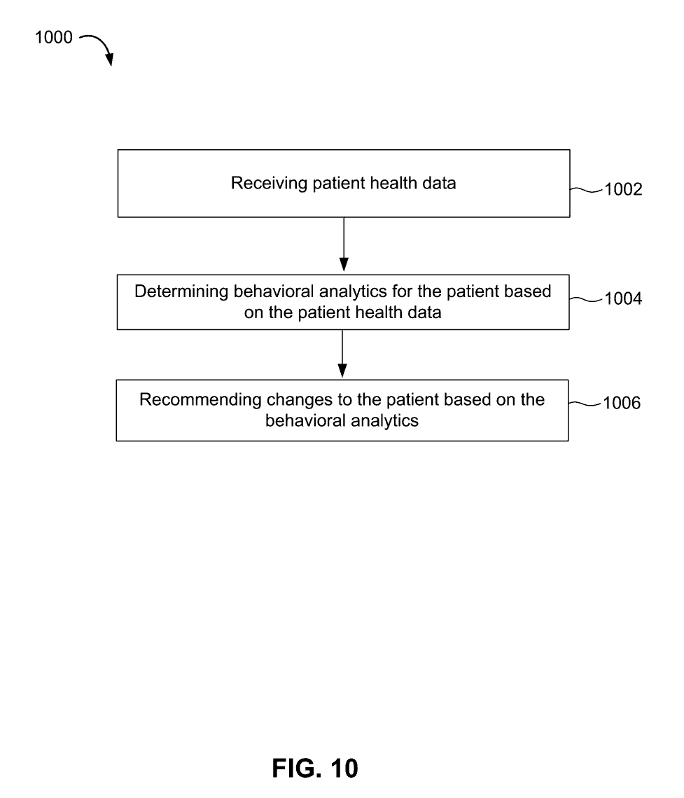

FIG. 10 illustrates an example method flow 1000 for determining behavioral analytics in accordance with an embodiment of the invention. The method 1000 may include receiving patient health data, including the patient's compliance and adherence scores, in step 1002. For example, system 10 may receive patient health data from one or more peripheral devices 24, the medication dispensing device 20, a patient account, health and wellness questions responses, medical history information, and/or a patient.

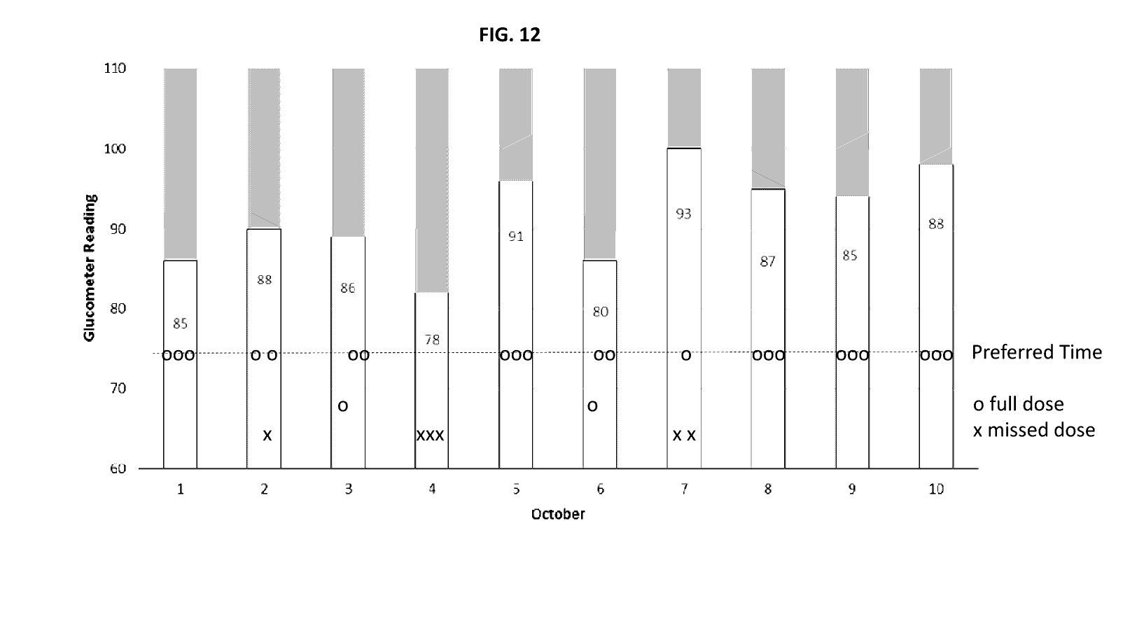

The system 10 may generate a chart (FIG. 12) showing adherence of each dose within a prescribed time window, along with corresponding biometric information. For example, FIG. 12 shows dose dates on the x-axis, with dots indicating the degree to which the doses were adherent to the corresponding dose window. The ideal dose time is shown in a horizontal dotted line, and the degree to which dots are distanced from the dotted line indicates how adherent the particular dose was. Missed doses are indicated with an “X”. Associated glucometer readings are implanted on the y axis, showing the results of missed or non-adherent doses of the medication on glucometer readings. Additional biometric readings may also be displayed as additional “swim lanes” of data, such as weight, blood pressure, etc.

The method may also include determining behavioral analytics for the patient based on the patient health data and compliance/adherence scores in step 1004. Behavioral analytics may include, but are not limited to, determining preferences of the patients, and determining preferences of a population of patients. Example behavioral analytics may include which times of day (or days of the week or related seasonality trends) are best for increasing medication compliance/adherence, which types of side effects caused by medications decrease adherence/compliance, and which types of alerts (e.g., audible, text message, e-mail) increase compliance/adherence.

In addition, the method may include recommending changes to a patient based on the behavioral analytics in step 1006. In an exemplary embodiment, system 10 may automatically update the recommended changes. For example, if system 10 determines that a patient consistently takes a medication later in the morning than the scheduled dosage window, system 10 may automatically update the dosage window for the medication. In addition, system 10 may learn that the patient responds best to telephone calls. Thus, system 10 may automatically modify alert notifications to be sent to the patient via telephone calls. In another embodiment, system 10 may suggest recommendations to the patient based on the determined behavioral analytics. For example, system 10 may determine that a population of patients with a similar disease state as the patient prefers to pick up medication refills every three months. System 10 may recommend to the patient to modify the patient's medication refill appointment based on the behavioral analytics of the population of patients. As such, the system may change alerts, medication dosage schedules, and/or patient recommendations, for example, as the system learns the behavior of the patient and/or a population of patients using the system.

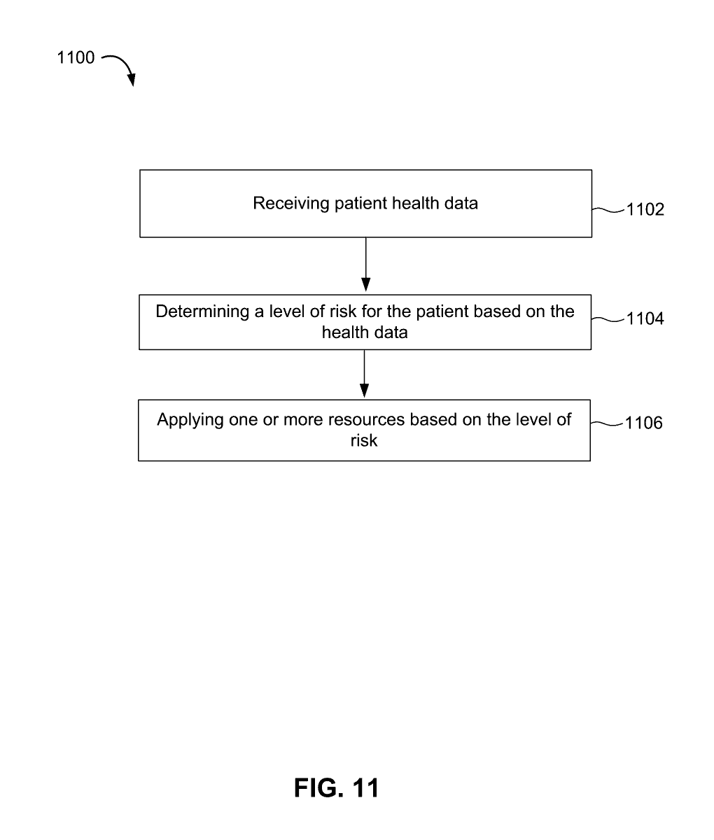

Referring now to FIG. 11, illustrated therein is an example method flow 1100 for risk management in accordance with an aspect. The method 1100 may include receiving patient health data in step 1102. For example, server 42 may receive patient health data from one or more peripheral devices 24, medication dispensing device 20, a patient account, health and wellness questions responses, medical history information, and a patient.

The method may also include determining a level of risk for the patient based on the health data in step 1104. For example, server 42 may analyze the patient's disease state, medical information, medication confirmation information, biometric readings, health and wellness information, and/or demographic data in determining the risk level for the patient.

The method may additionally include applying one or more resources based on the level of risk in step 1106. For example, server 42 may allocate more system resources to patients of higher risk than the amount of resources allocated to patients of lower risk. Server 42 may increase third party monitoring of the patient's health data, biometric measurements, and medication confirmation information, for example, when the system determines that the patient may be a high risk. In addition, server 42 may increase the amount of alerts and/or notifications transmitted to the patient, caregivers, family members, pharmacist, and medical providers when server 42 determines that the patient may be a high risk.

Aspects of the disclosure may be implemented using hardware, software, or a combination thereof and may be implemented in one or more computer systems or other processing systems. In an aspect of the disclosure, features are directed toward one or more computer systems capable of carrying out the functionality described herein.

While the foregoing disclosure discusses example aspects and/or features, it should be noted that various changes and modifications could be made herein without departing from the scope of the described aspects and/or features as defined by the appended claims. Furthermore, although elements of the described aspects and/or features may be described or claimed in the singular, the plural is contemplated unless limitation to the singular is explicitly stated. Additionally, all or a portion of any aspect and/or embodiment may be utilized with all or a portion of any other aspect and/or feature, unless stated otherwise.

What is claimed is:

1. A method of calculating a compliance score, comprising:
receiving medication confirmation information;
receiving patient data and biometric data;
calculating a compliance score based on a medication dosage schedule for the patient using the medication confirmation information, the patient data, and the biometric data; and
transmitting the compliance score,
wherein calculating the compliance score includes dividing a total number of doses of a particular medication consumed in a period of time based on the medication confirmation information by a total amount of doses prescribed to the patient in the period of time based on the medication dosage schedule.
